(19) United States
(12) Patent Application Publication
(10) Pub. No.: US 2010/0305723 A1
(43) Pub. Date: Dec. 2, 2010

(54) ELECTRONIC CONTROL UNIT

(75) Inventor: Yutaka KOYAMA, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/791,297

(22) Filed: Jun. 1, 2010

(30) Foreign Application Priority Data
Jun. 1, 2009 (JP) 2009-132006

(51) Int. Cl. G06F 17/00

(52) U.S. Cl. 700/90

(57) ABSTRACT

The present invention provides, as one aspect, an electronic control unit, including a plurality of control circuits having a communication function, the control circuits including a main control circuit and a sub-control circuit, and a signal conversion circuit which is connected to an external bus to acquire a transmission signal passing through the bus and output a transmission signal produced in each of the control circuits to the bus. The main control circuit outputs a power-on signal to the signal conversion circuit to turn on the signal conversion circuit. The sub-control circuit starts communication using the communication function when a predetermined power-on condition is met, the power-on condition indicating power-on of the signal conversion circuit.

### CROSS-REFERENCE TO RELATED APPLICATION

This application is based on and claims the benefit of priority from earlier Japanese Patent Application No. 2009-132006 filed Jun. 1, 2009, the description of which is incorporated herein by reference.

### BACKGROUND OF THE INVENTION

1. Technical Field of the Invention

The present invention relates to an electronic control unit which enables data communication with an external unit via a communication bus.

2. Related Art

Conventionally, vehicles have been incorporated a number of electronic control units (ECUs) to control in-car equipment. These ECUs share control data with each other, or are connected to each other in a data-communicable manner via a communication bus, such as CAN (controller area network) and LIN (local interconnect network), for consolidated control of the vehicle.

The number of ECUs incorporated in a vehicle is increasing due to the high performance of the in-car equipment, the improvement of safety, and the like. Accordingly, the number of ECUs connected to a communication bus is increasing. However, the increase in the number of ECUs connected to a communication bus necessitates an increase in the length of wiring. This has raised a problem of complexity in the design of the wiring route that can ensure good communication quality, and another problem of difficulty in maintaining the good communication quality.

In recent years, in order to reduce the number of ECUs to be incorporated in a vehicle, projections are underway to develop an ECU which is able to perform all of the functions that have been performed by a plurality of ECUs.

Developing an ECU that can perform several functions in a consolidated manner involves developing a new design of a control circuit (generally, a microcomputer) suitable for all of the functions. Developing a new design (specifically, developing software) may raise a problem of incurring cost. Moreover, such a control circuit suitable for all of the functions accompanies the increase of a processing load of the control circuit. This may raise another problem of having to take measures against the increase of the processing load. These measures may include: configuring a control circuit as a microcomputer that enables processing at a speed higher than conventional microcomputers; and efficiently radiating heat generated in the microcomputer due to the increase of power consumption of the control circuit with the increase of the processing load.

In developing an ECU that can perform the functions of a plurality of ECUs in a consolidated manner, development of a new design of a control circuit having multiple functions should preferably be avoided. It is desirable that the plurality of control circuits of the individual conventional ECUs be incorporated into a single ECU.

Incorporation of the plurality of control circuits into a single ECU can dispense with a development of a new design of a control circuit. In addition, since the existing control circuits can be utilized for the consolidation of the conventional ECUs, the specification of the vehicle control system concerned can be changed comparatively easily and at low cost.

Meanwhile, each of control circuits has a communication function. Therefore, the incorporation of the plurality of control circuits into a single ECU may necessitate connecting this ECU to a communication bus using a communication line of a single system.

To this end, a signal conversion circuit (e.g., CAN transceiver) that transmits/receives data between the ECU and an external unit via the communication bus may be shared between the plurality of control circuits. In this regard, reference may be made, for example, to patent documents JP-A-2002-204243 and JP-A-2007-243317.

These patent documents JP-A-2002-204243 and JP-A-2007-243317 each disclose a technique with which a signal conversion circuit in a single ECU selects high priority communication data from among the data outputted from a plurality of control circuits which are incorporated into the ECU, and outputs the selected data to a communication bus. For example, low-level data are set so as to have higher priority than high-level data.

Reference is made to the accompanying FIGS. 9A to 9F to explain the communication in which low-level data have priority over high-level data. As shown in FIGS. 9A to 9F, a signal conversion circuit in an ECU is turned on at certain timing (see time t12 of FIG. 9E). At this timing, if a control circuit B among a plurality of control circuits in the ECU is in a power-off state (see time t12 of FIG. 9C), the data from the control circuit B will be of a low level (see time t12 of FIG. 9D). Therefore, the low-level data are kept outputted to the communication bus (see time t12 to time 13 of FIG. 9F). As a result, communication is problematically disabled between all the ECUs connected to the communication bus.

Further, a certain control circuit (control circuit A of FIG. 9A) may start a communication process (see time t11 of FIG. 9B) before the signal conversion circuit in the single ECU is turned on (i.e. before t12 of FIGS. 9A to 9F). In this case, a communication error may occur (see time t11 to time t12 of FIG. 9B). Therefore, the control circuit A, at the timing when it is enabled communication thereafter, will output an error frame (low-level data) to the communication bus. As a result, communication is problematically interrupted between all the ECUs connected to the communication bus.

### SUMMARY OF THE INVENTION

The present invention has been made in light of the problems set forth above and has as its object to provide a technique for enhancing reliability of communication functions in an electronic control unit (ECU) that includes a plurality of control circuits each having a communication function.

In order to achieve the above object, the present invention provides, as one aspect, an electronic control unit, including: a plurality of control circuits having a communication function, the control circuits including a main control circuit and a sub-control circuit; and a signal conversion circuit which is connected to an external bus to acquire a transmission signal passing through the bus and output a transmission signal produced in each of the control circuits to the bus, wherein the main control circuit outputs a power-on signal to the signal conversion circuit to turn on the signal conversion circuit, and the sub-control circuit starts communication using the communication function when a predetermined power-on condition is met, the power-on condition indicating power-on of the signal conversion circuit.

### BRIEF DESCRIPTION OF THE DRAWINGS

In the accompanying drawings:

FIG. 1 is a block diagram illustrating the configuration of an electronic control unit (ECU) according to a first embodiment of the present invention;

FIG. 2 is a flow diagram illustrating a first power-on process performed by the ECU;

FIG. 3 is a flow diagram illustrating a first communication start process performed by the ECU;

FIGS. 4A to 4F are timing diagrams illustrating the communication start operation performed by the ECU;

FIG. 5 is a flow diagram illustrating a first communication start process according to a second embodiment of the present invention;

FIG. 6 is a block diagram illustrating the configuration of an electronic control unit (ECU) according to a third embodiment of the present invention;

FIG. 7 is a flow diagram illustrating a second power-on process performed by the ECU according to the third embodiment;

FIG. 8 is a flow diagram illustrating a second communication start process performed by the ECU according to the third embodiment; and

FIGS. 9A to 9F are timing diagrams illustrating problems at the time of starting communication in the conventional art.

### DETAILED DESCRIPTION OF THE PREFERRED EMBODIMENTS

### First Embodiment

With reference to the accompanying drawings, hereinafter will be described some embodiments of the present invention.

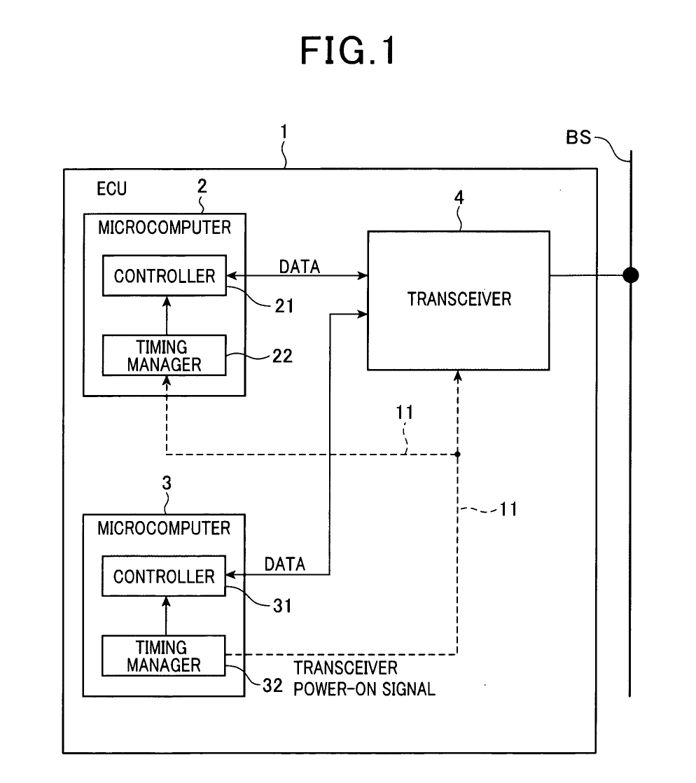

Referring to FIGS. 1 to 3 and FIGS. 4A to 4F, a first embodiment of the present invention is described. FIG. 1 is a block diagram illustrating the configuration of an electronic control unit (hereinafter referred to as “ECU”) 1 according to the first embodiment.

The ECU 1 of the present embodiment is incorporated in a vehicle and used for controlling given equipment, such as an engine, to be controlled. The ECU 1 is connected to a bus BS together with ECUs (not shown) that control other in-car equipment. In the present embodiment, the bus BS is a known CAN (controller area network) bus. The ECU 1 performs data communication with other ECUs via the bus BS to transmit/receive data necessary for controlling the equipment to be controlled.

The ECU 1 includes microcomputers 2 and 3, and a transceiver 4. The microcomputers 2 and 3 each include a CPU, ROM, RAM, I/O and a bus line connecting these components. The transceiver 4 permits communication between the ECU 1 and other ECUs via the bus BS.

The microcomputer 2 includes a controller 21 that transmits/receives data via the transceiver 4, and a timing manager 22 that manages the timing of communication start of the controller 21. Similarly, the microcomputer 3 includes a controller 31 that transmits/receives data via the transceiver 4, and a timing manager 32 that manages the timing of communication start of the controller 31.

The transceiver 4 composes data from the microcomputers 2 and 3, setting priority to low-level data and outputs the composed data to the bus BS. Specifically, the transceiver 4 obtains data from the microcomputers 2 and 3. If the data from either of the microcomputers 2 and 3 is of a low level, the output value of the data with respect to the bus (hereinafter referred to as “bus output value”) is set to a low level. If the data from both of the microcomputers 2 and 3 is of a high level, the bus output value of the data is set to a high level. The transceiver 4 converts the set bus output value to a value in conformity with the communication protocol and transmits the converted value to the bus BS. In the event signals from the microcomputers 2 and 3 collide with each other, the arbitration of the collision is not performed by the transceiver 4 but by the controllers 21 and 31 installed in the microcomputers 2 and 3, respectively.

A signal line 11 is connected between the microcomputer 3 and the transceiver 4, and between the microcomputers 2 and 3. The signal line 11 is used for transmitting a transceiver power-on signal (described later) outputted from the microcomputer 3. The signal line 11 is usually set to a low level but turns to a high level when the transceiver power-on signal is transmitted.

The microcomputer 2 has an application which is started when the microcomputer 2 is connected to the battery of the vehicle. The microcomputer 3 has an application which is started when the ignition (IG) switch (not shown) of the vehicle is turned on. Thus, the ECU 1 is configured such that the microcomputer 2 is turned on earlier than the microcomputer 3.

In the ECU 1 configured in this way, the timing manager 32 of the microcomputer 3 executes a first power-on process to turn on the transceiver 4. Also, the timing manager 22 of the microcomputer 2 executes a first communication start process to permit the controller 21 to start communication.

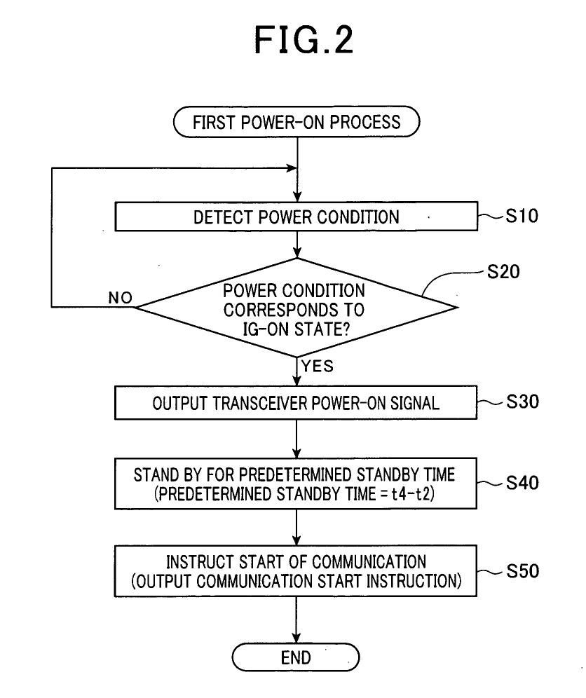

Referring to FIG. 2, hereinafter is explained the procedure of the first power-on process executed by the timing manager 32 of the microcomputer 3. FIG. 2 is a flow diagram illustrating the first power-on process. The first power-on process is a process executed only once immediately after start of the microcomputer 3.

Upon execution of the first power-on process, the timing manager 32 detects, in step S10, the condition of the power (power condition) of the microcomputer 3. Then, in step S20, it is determined whether or not the power condition of the microcomputer 3 corresponds to an IG-on state (a state where the IG switch is turned on) based on the result of the detection on the power condition in step S10. If the power condition does not correspond to the IG-on state (NO in step S20), control returns to step S10 where the timing manager 32 repeats the above processing in step S10.

On the other hand, if the power condition corresponds to the IG-on state (YES in step S20), control proceeds to step S30. In step 30, the timing manager 32 outputs a transceiver power-on signal, instructing to turn on the transceiver 4. The transceiver 4, being inputted with the transceiver power-on signal, turns on itself.

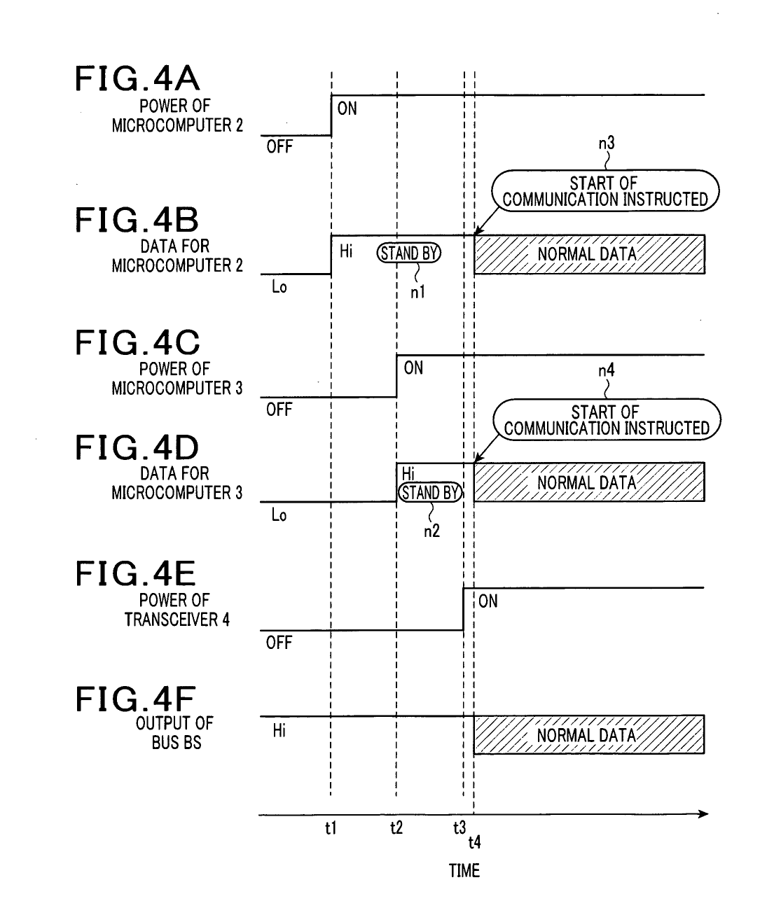

Then, in step S40, control stands by until a predetermined standby time (e.g., one second in the present embodiment) expires. The standby time is provided for the purpose of starting communication after the transceiver 4 has reliably turned to a power-on state. The standby time corresponds to the period between time t2 and time t4 in FIGS. 4A to 4F.

Then, in step S50, the timing manager 32 instructs the controller 31 to start communication, or in other words, the timing manager 32 outputs an instruction for starting communication to the controller 31 to thereby end the first power-on process. Thus, the controller 31 of the microcomputer 3 starts communication via the bus BS.

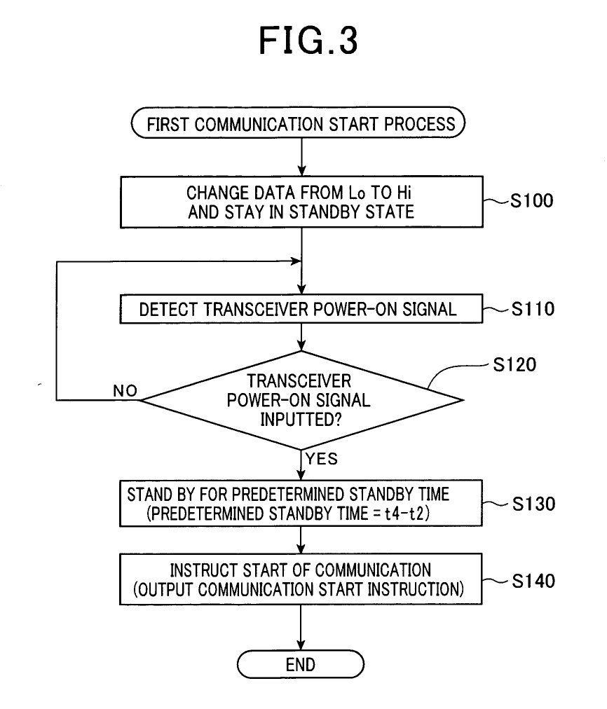

Referring to FIG. 3, hereinafter is described the procedure of a first communication start process executed by the timing manager 22 of the microcomputer 2. FIG. 3 is a flow diagram illustrating the first communication start process. The first communication start process is a process executed only once immediately after start of the microcomputer 2.

Upon execution of the first communication start process, the timing manager 22 changes data, in step S100, from a low level to a high level, while allowing the microcomputer 2 to stand by. Further, in step S110, a transceiver power-on signal is detected in order to determine whether or not the transceiver power-on signal has been inputted from the microcomputer 3.

Then, in step S120, it is determined whether or not the transceiver power-on signal has been inputted, based on the result of the detection in step S110. Specifically, it is determined whether or not the transceiver 4 has been turned on. If the transceiver power-on signal has not been inputted (NO in step S120), the transceiver 4 is determined as being in a power-off state. Then, control returns to step S110 to stand by until a transceiver power-on signal is inputted, while repeating the above processing in step S110. The standby time corresponds to the period between time t1 and time t2 in FIGS. 4A to 4F.

On the other hand, if the transceiver power-on signal has been inputted (YES in step S120), the transceiver 4 is determined as being in a power-on state. Then, control proceeds to step S130 where control stands by until a predetermined standby time (e.g., one second in the present embodiment) expires. The standby time is provided for the purpose of starting communication after the transceiver 4 has reliably turned to a power-on state. The standby time corresponds to the period between time t2 and time t4 in FIGS. 4A to 4F.

Then, in step S140, the timing manager 22 instructs the controller 21 to start communication, or in other words, the timing manager 22 outputs an instruction for starting communication to the controller 21 to thereby end the first communication start process. Thus, the controller 21 of the microcomputer 2 starts communication via the bus BS.

Referring to FIGS. 4A to 4F, hereinafter is described an operation which is performed in the ECU 1 when the ECU 1 starts communication via the bus BS. FIGS. 4A to 4F are timing diagrams illustrating a communication start operation performed in the ECU 1.

First, the microcomputer 2 is turned on (see time t1 of FIG. 4A). In accordance with this power-on operation, a communication signal line of the microcomputer 2 turns to a high level (see time t1 of FIG. 4B). In this case, the microcomputer 2 does not start communication but stands by (see instruction n1). Then, the microcomputer 3 is turned on (see time t2 of FIG. 4C). In accordance with this power-on operation, a communication signal line of the microcomputer 3 turns to a high level (see time t2 of FIG. 4D). In this case, the microcomputer 3 does not start communication as well but stands by (see instruction n2).

Then, when a transceiver power-on signal is outputted from the microcomputer 3 to the transceiver 4, the transceiver 4 is turned on (see time t3 of FIG. 4E). After that, the microcomputers 2 and 3 each issue an instruction to start communication, being triggered by the output of the transceiver power-on signal from the microcomputer 3 to the transceiver 4 (see instructions n3 and n4). As a result, communication is started (see time 4 of FIGS. 4B, 4D and 4F).

The ECU 1 configured in this way includes two or more microcomputers, i.e. the microcomputers 2 and 3, each having a function of performing communication via the bus BS. The ECU 1 also includes the transceiver 4 which is connected to the external bus BS to acquire transmission signals passed through the bus BS and output transmission signals produced in the individual microcomputers 2 and 3 to the bus BS. Of the microcomputers 2 and 3, the microcomputer 3, which is selected in advance, outputs a transceiver power-on signal to the transceiver 4 to turn on the transceiver 4. Of the microcomputers 2 and 3, the microcomputer 2 different from the microcomputer 3 starts communication via the bus BS upon input of the transceiver power-on signal from the microcomputer 3.

Specifically, in the ECU 1, the transceiver 4 is turned on when a transceiver power-on signal is outputted from the microcomputer 3 to the transceiver 4. Thus, the microcomputer 3, when it has outputted a transceiver power-on signal, can determine that the transceiver 4 has turned to a power-on state. The microcomputer 3 allows start of communication via the bus BS after outputting a transceiver power-on signal and after expiration of a predetermined standby time. Therefore, the microcomputer 3 can start communication via the bus BS after the transceiver 4 has turned to a power-on state.

Further, upon the input of the transceiver power-on signal from the microcomputer 3, which indicates that the transceiver 4 has turned to a power-on state, the microcomputer 2 starts communication via the bus BS. Thus, similar to the microcomputer 3, the microcomputer 2 can start communication via the bus BS after the transceiver 4 has turned to a power-on state.

In this way, all of the two or more microcomputers 2 and 3 configuring the ECU 1 can start communication via the bus BS after the transceiver 4 has turned to a power-on state.

Therefore, the occurrence of an error can be suppressed, which error would have occurred due to the start of communication by the microcomputers 2 and 3 before the transceiver 4 is turned on. Thus, reliability of communication via the bus BS can be enhanced.

Of the microcomputers 2 and 3, the microcomputer 3 which is lastly turned on is ensured to output a transceiver power-on signal. Therefore, the transceiver 4 is turned on after all of the plural microcomputers 2 and 3 configuring the ECU 1 have been turned on. In other words, no microcomputers are in a power-off state at the time point when the transceiver 4 has turned to a power-on state allowing communication via the bus BS.

Thus, communication can be prevented from being disabled due to the presence of the microcomputers 2 and 3 which are in a power-off state, irrespective of the fact that the transceiver 4 has turned to a power-on state. Thus, the reliability of communication via the bus BS can be enhanced.

Besides the transceiver 4, the transceiver power-on signal is also inputted to the microcomputer 2 from the microcomputer 3, whereby the microcomputer 2 can detect that the microcomputer 3 has outputted the transceiver power-on signal to the transceiver 4. Thus, the microcomputer 3 does not have to separately produce a signal indicative of the fact that the microcomputer 3 has outputted the transceiver power-on signal, and to output the separately produced signal to the microcomputer 2. As a result, the configuration of the microcomputer 3 can be simplified.

In the embodiment described above, the microcomputer 3 corresponds to the main control circuit, the microcomputer 2 corresponds to the sub-control circuit, the transceiver 4 corresponds to the signal conversion circuit, the transceiver power-on signal corresponds to the power-on signal, and the determination condition in step S120 corresponds to the power-on condition.

### Second Embodiment

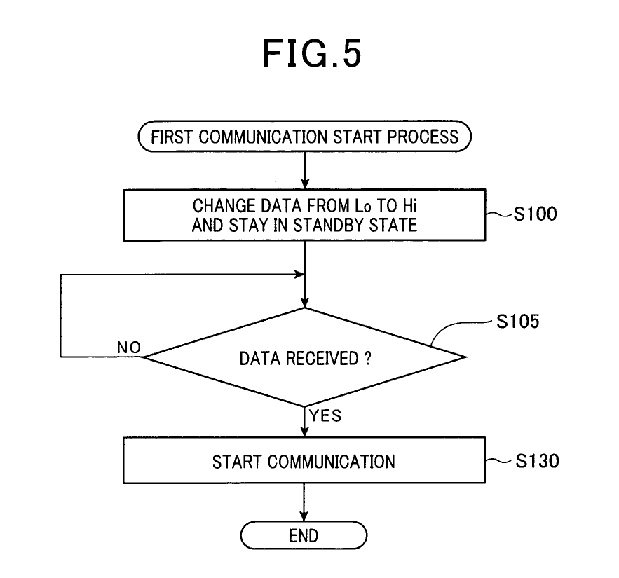

With reference to FIG. 5, hereinafter is described a second embodiment of the present invention. In the second and the subsequent embodiments, the components identical with or similar to those in the first embodiment are given the same reference numerals for the sake of omitting explanation. Also, in the second embodiment, only those portions which are different from the first embodiment are described.

The ECU 1 of the second embodiment is the same as that of the first embodiment except that the first communication start process executed by the microcomputer 2 has been changed.

Referring to FIG. 5, a first communication start process of the second embodiment is described. FIG. 5 is a flow diagram illustrating the first communication start process according to the second embodiment.

The first communication start process according to the second embodiment is the same as that of the first embodiment except that steps S110 and 5120 have been omitted and a step S105 has been added.

Specifically, upon execution of the first communication start process, it is determined, in step S105, whether or not data has been received via the transceiver 4. If no data has been received (NO in step S105), control stands by, repeating the processing of step S105. If data has been received (YES in step 5105), control proceeds to step S130.

According to the ECU 1 configured in this way, communication can be started after the transceiver 4 has reliably turned to a power-on state. This is because reception of data via the transceiver 4 means that the transceiver 4 is in a power-on state.

### Third Embodiment

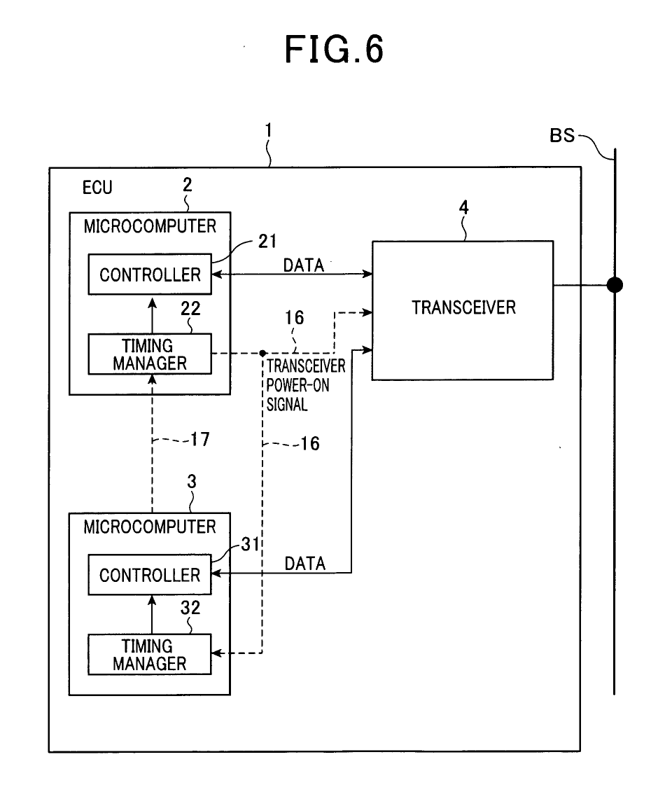

With reference to FIGS. 6 to 8, hereinafter is described a third embodiment. In the third embodiment, only those portions which are different from the first embodiment are described.

The ECU 1 of the third embodiment is the same as that of the first embodiment except that: the configuration of the ECU 1 has been changed; the microcomputer 2 executes a second power-on process instead of the first communication start process; and the microcomputer 3 executes a second communication start process instead of the first power-on process.

FIG. 6 is a block diagram illustrating the configuration of the ECU 1 according to the third embodiment.

As shown in FIG. 6, the ECU 1 of the third embodiment is the same as that of the first embodiment except that the signal line 11 has been omitted and signal lines 16 and 17 have been added.

The signal line 16 connects between the microcomputer 2 and the transceiver 4 and between the microcomputers 2 and 3, such that a signal can be inputted/outputted therebetween and that a transceiver power-on signal (described later) outputted from the microcomputer 2 can be transmitted. The signal line 17 connects between the microcomputers 2 and 3, such that a signal can be inputted/outputted therebetween and that a signal indicative of a power level of the microcomputer 3 (hereinafter referred to as “power level signal”) can be transmitted.

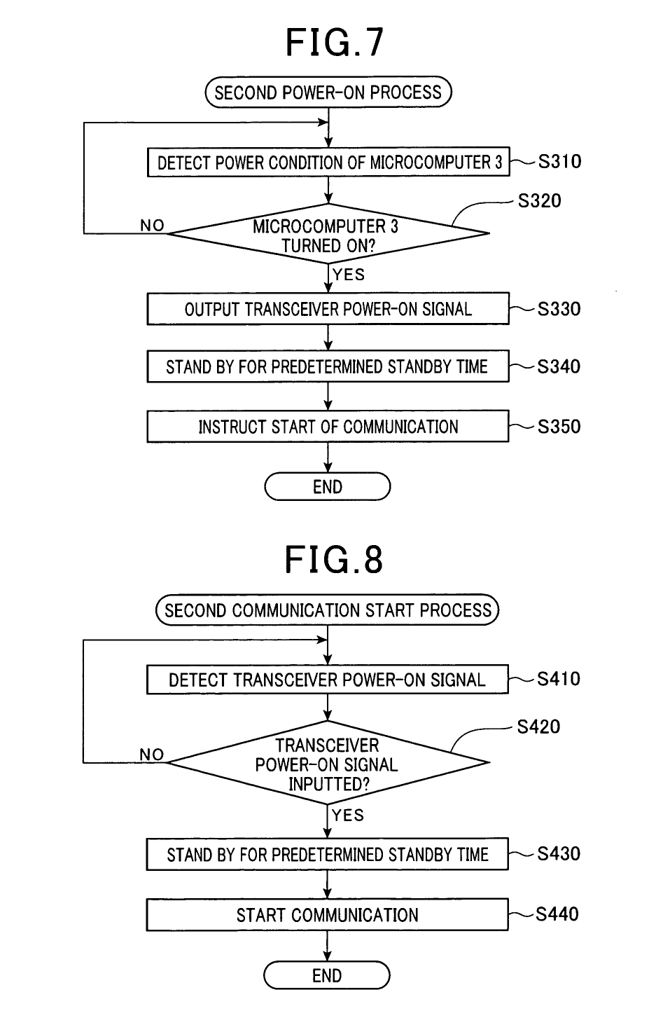

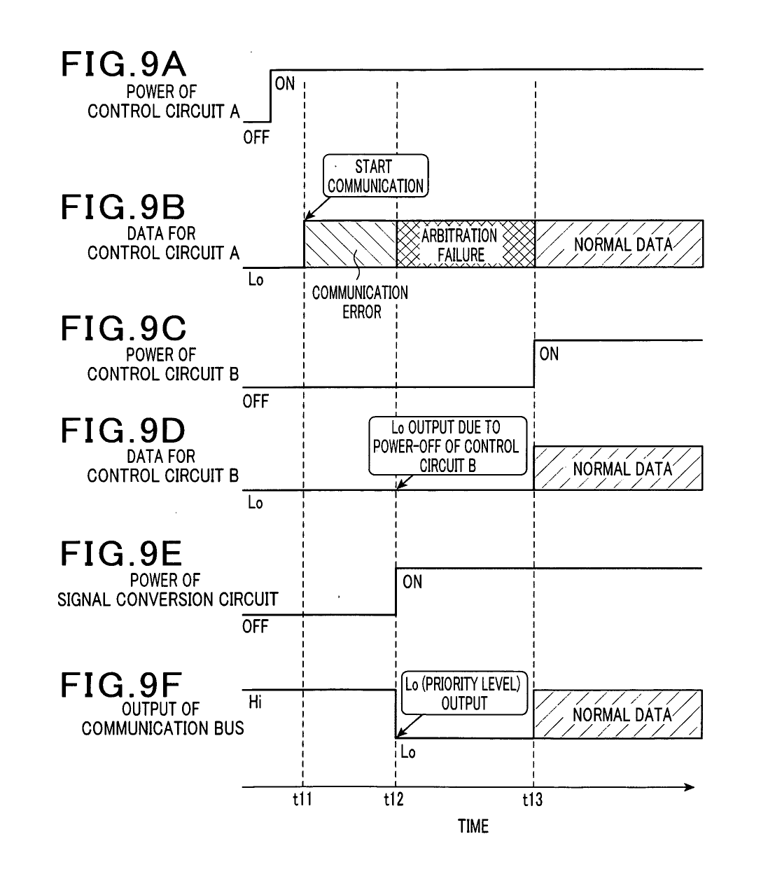

Referring to FIG. 7, hereinafter is described a procedure of the second power-on process executed by the timing manager 22 of the microcomputer 2. FIG. 7 is a flow diagram illustrating the second power-on process. The second power-on process is a process executed only once immediately after start of the microcomputer 2.

Upon execution of the second power-on process, the timing manager 22 detects, in step S310, the power condition of the microcomputer 3, based on a power level signal from the microcomputer 3. Then, in step S320, it is determined whether or not the microcomputer 3 is in a power-on state, based on the result of the detection of the power condition in step S310. If the microcomputer 3 is not in a power-on state (NO in step S320), control returns to step S310 to repeat the processing mentioned above.

If the microcomputer 3 is in a power-on state (YES in step S320), control proceeds to step S330. In step S330, the timing manager 22 outputs a transceiver power-on signal instructing to turn on the transceiver 4. Then, the transceiver 4, being inputted with the transceiver power-on signal, turns on itself.

Then, in step S340, control stands by until a predetermined standby time (e.g., one second in the present embodiment) expires.

Then, in step S350, the timing manager 22 instructs the controller 21 to start communication and ends the second power-on process. Thus, the controller 21 of the microcomputer 2 starts communication via the bus BS.

Referring to FIG. 8, hereinafter is described the second communication start process executed by the timing manager 32 of the microcomputer 3. FIG. 8 is a flow diagram illustrating the second communication start process. The second communication start process is a process executed only once immediately after start of the microcomputer 3.

Upon execution of the second communication start process, the timing manager 32 detects, in step S410, a transceiver power-on signal in order to determine whether or not the transceiver power-on signal has been inputted from the microcomputer 2.

Then, in step 5420, it is determined whether or not the transceiver power-on signal has been inputted, based on the result of the detection in step S410. Specifically, it is determined whether or not the transceiver 4 has turned to a power-on state. If the transceiver power-on signal has not been inputted (NO in step S420), the transceiver 4 is determined as being in a power-off state. Then, control returns to step S410 to repeat the processing of step S410 mentioned above.

On the other hand, if the transceiver power-on signal has been inputted (YES in step S420), the transceiver 4 is determined as being in a power-on state. Then, control proceeds to step S430 where control stands by until a predetermined standby time (e.g., one second in the present embodiment) expires.

Then, in step S440, the timing manager 32 instructs the controller 31 to start communication to thereby end the second communication start process. Thus, the controller 31 of the microcomputer 3 starts communication via the bus BS.

In the ECU 1 configured in this way, of the plural microcomputers 2 and 3, the microcomputer 2 is the microcomputer which is turned on first of all. Also, the microcomputer 2 outputs a transceiver power-on signal after all of the plural microcomputers 2 and 3 have been turned on. Therefore, the transceiver 4 is turned on after all of the plural microcomputers 2 and 3 have been turned on. In other words, no microcomputers are in a power-off state at the time point when the transceiver 4 has turned to a power-on state allowing communication by communication functions.

Thus, communication can be prevented from being disabled due to the presence of the microcomputers 2 and 3 in a power-off state, irrespective of the fact that the transceiver 4 has turned to a power-on state. Thus, the reliability of communication via the bus BS can be enhanced.

Some embodiments of the present invention have been described so far. However, the present invention is not intended to be limited to the embodiments described above, but may be variably modified as far as the modifications fall within a technical scope of the present invention.

For example, the ECU 1 in each of the above embodiments has installed two microcomputers, but may have three or more microcomputers.

Also, in the first embodiment, it is so configured that the microcomputer 2 determines the transceiver 4 as being in a power-on state, based on the fact that a transceiver power-on signal has been inputted from the microcomputer 3. Alternatively, however, it may be so configured that the microcomputer 2 directly detects the power condition of the transceiver 4.

In the first embodiment, it has been so configured that the output of a transceiver power-on signal from the microcomputer 3 is detected, when the microcomputer 2 has received the transceiver power-on signal from the microcomputer 3. Alternatively, however, it may be so configured that the microcomputer 2 performs inter-microcomputer communication (e.g., DMA (direct memory access) communication, serial communication, or the like) with the microcomputer 3 to detect the fact that the microcomputer 3 has outputted a transceiver power-on signal. Thus, in the case where the inter-microcomputer communication has already been used between the microcomputers 2 and 3, the software may just be changed for the transmission of the information that the microcomputer 3 has outputted the transceiver power-on signal. In this way, with a simple scheme of changing the software, the microcomputer 2 can detect, via the inter-microcomputer communication, the fact that the microcomputer 3 has outputted the transceiver power-on signal, without the necessity of changing the hardware.

Alternatively, a generally used scheme of inputting/outputting high-level and low-level signals may be used for the communication between the microcomputers 2 and 3. With this scheme as well, the microcomputer 2 can detect the fact that the microcomputer 3 has outputted the transceiver power-on signal. A generally used signal inputting/outputting function is usually installed in a microcomputer by default. Using this generally used signal inputting/outputting function, the microcomputer 3 can be ensured to output a signal to the microcomputer 2, the signal indicating the fact of outputting a transceiver power-on signal. In this way, even in the case where neither the microcomputer 2 nor the microcomputer 3 has the function of performing inter-microcomputer communication, the microcomputer 2 can detect the fact that the microcomputer 3 has outputted the transceiver power-on signal.

In the third embodiment, the microcomputer 2 has been ensured to determine whether or not the microcomputer 3 is in a power-on state, based on a power level signal from the microcomputer 3. Alternatively, however, the microcomputer 2 may perform inter-microcomputer communication with the microcomputer 3 and then determine that the microcomputer 3 is in a power-on state, based on the fact that the inter-microcomputer communication has been successful. In this way, only a slight change of the software can achieve a scheme of detecting power-on of the microcomputer 3, without increasing the amount of data of communication between the microcomputers 2 and 3.

Hereinafter, aspects of the above-described embodiments will be summarized.

The above embodiments provide, as one aspect, an electronic control unit, including: a plurality of control circuits having a communication function, the control circuits including a main control circuit and a sub-control circuit; and a signal conversion circuit which is connected to an external bus to acquire a transmission signal passing through the bus and output a transmission signal produced in each of the control circuits to the bus, wherein the main control circuit outputs a power-on signal to the signal conversion circuit to turn on the signal conversion circuit, and the sub-control circuit starts communication using the communication function when a predetermined power-on condition is met, the power-on condition indicating power-on of the signal conversion circuit.

According to this configuration, the signal conversion circuit is turned on based on the fact that the main control circuit has outputted a power-on signal to the signal conversion circuit. Therefore, having outputted a power-on signal, the main control circuit can determine that the signal conversion circuit has turned to a power-on state. Thus, the main control circuit can start communication using communication functions after outputting the power-on signal. Specifically, the main control circuit can start communication using the communication functions after the signal conversion circuit has turned to a power-on state.

When a predetermined power-on condition, which indicates power-on of the signal conversion circuit, is met, the sub-control circuit starts communication using the communication functions. Accordingly, similar to the main control circuit, the sub-control circuit can also start communication using the communication functions after the signal conversion circuit has turned to a power-on state.

In this way, all of the plural control circuits configuring the ECU can start communication using the communication functions after the signal conversion circuit has turned to a power-on state.

Thus, the occurrence of a communication error can be suppressed, which would have been ascribed to permitting the control circuit to start communication before the signal conversion circuit turns to a power-on state. As a result, reliability of communication functions can be enhanced.

In the electronic control unit, the main control circuit is a control circuit which is turned on lastly between the plurality of control circuits, and the power-on condition is the fact that the main control circuit has outputted the power-on signal.

According to this configuration, the control circuit lastly turned on is ensured to output a power-on signal. Therefore, the signal conversion circuit is turned on after all of the plural control circuits configuring the ECU have been turned on. In other words, no control circuits are in a power-off state at the time when the signal conversion circuit has turned to a power-on state allowing communication using the communication functions.

Thus, communication can be prevented from being disabled due to the presence of the control circuits which are in a power-off state, irrespective of the fact that the signal conversion circuit has turned to a power-on state. Thus, the reliability of the communication via the communication functions can be enhanced.

In the electronic control unit, the sub-control circuit detects the fact that the main control circuit has outputted the power-on signal via inter-microcomputer communication with the main control circuit.

According to this configuration, in the case where inter-microcomputer communication, such as DMA (direct memory access) communication and serial communication, has already been used between the main control circuit and the sub-control circuit, the software may just be changed for the transmission of the information that the main control circuit has outputted the power-on signal to the sub-control circuit. In this way, with a simple scheme of changing the software, the sub-control circuit can detect, via the inter-microcomputer communication, the fact that the main control circuit has outputted the power-on signal, without the necessity of changing the hardware.

In the electronic control unit, the sub-control circuit detects the fact that the main control circuit has outputted the power-on signal by a generally used scheme of inputting/outputting high-level and low-level signals used for communication between the sub-control circuit and the main control circuit.

Specifically, a generally used signal inputting/outputting function is usually installed in a microcomputer by default. Using this generally used signal inputting/outputting function, the main control circuit can be ensured to output a signal to the sub-control circuit, the signal indicating the fact of outputting a power-on signal. In this way, even in the case where neither the main control circuit nor the sub-control circuit has a function of inter-microcomputer communication, the sub-control circuit can detect the fact that the main control circuit has outputted the power-on signal.

In the electronic control unit, the sub-control circuit detects the fact that the main control circuit has outputted the power-on signal by receiving the power-on signal from the main control circuit.

According to this configuration, the main control circuit no longer requires to output a signal to the sub-control circuit, the signal indicating that a power-on signal has been outputted. Accordingly, the configuration of the main control circuit can be simplified.

In the electronic control unit, the power-on condition is the fact that the sub-control circuit has received the transmission signal passing through the bus via the signal conversion circuit.

Specifically, reception of a transmission signal means that the signal conversion circuit has turned to a power-on state. According to this configuration, communication can be started after the signal conversion circuit has reliably turned to a power-on state.

In the electronic control unit, the main control circuit is a control circuit which is turned on firstly between the plurality of control circuits, and the main control circuit outputs the power-on signal after all of the plurality of control circuits have been turned on.

According to this configuration, the signal conversion circuit is turned on after all of the plural control circuits have been turned on.

Specifically, no control circuits are in a power-off state at the time when the signal conversion circuit has turned to a power-on state allowing communication using the communication functions.

Thus, communication can be prevented from being disabled due to the presence of the control circuits which are in a power-off state, irrespective of the fact that the signal conversion circuit has turned to a power-on state. Thus, the reliability of the communication via the communication functions can be enhanced.

What is claimed is:

1. An electronic control unit, comprising:
a plurality of control circuits having a communication function, the control circuits including a main control circuit and a sub-control circuit; and
a signal conversion circuit which is connected to an external bus to acquire a transmission signal passing through the bus and output a transmission signal produced in each of the control circuits to the bus, wherein
the main control circuit outputs a power-on signal to the signal conversion circuit to turn on the signal conversion circuit, and
the sub-control circuit starts communication using the communication function when a predetermined power-on condition is met, the power-on condition indicating power-on of the signal conversion circuit.

2. The electronic control unit according to claim 1, wherein the main control circuit is a control circuit which is turned on lastly between the plurality of control circuits, and
the power-on condition is the fact that the main control circuit has outputted the power-on signal.

3. The electronic control unit according to claim 2, wherein the sub-control circuit detects the fact that the main control circuit has outputted the power-on signal via inter-microcomputer communication with the main control circuit.

4. The electronic control unit according to claim 2, wherein the sub-control circuit detects the fact that the main control circuit has outputted the power-on signal by a generally used scheme of inputting/outputting high-level and low-level signals used for communication between the sub-control circuit and the main control circuit.

5. The electronic control unit according to claim 2, wherein the sub-control circuit detects the fact that the main control circuit has outputted the power-on signal by receiving the power-on signal from the main control circuit.

6. The electronic control unit according to claim 1, wherein the power-on condition is the fact that the sub-control circuit has received the transmission signal passing through the bus via the signal conversion circuit.

7. The electronic control unit according to claim 1, wherein the main control circuit is a control circuit which is turned on firstly between the plurality of control circuits, and
the main control circuit outputs the power-on signal after all of the plurality of control circuits have been turned on.
